(19) United States
(12) Patent Application Publication
(10) Pub. No.: US 2021/0387149 A1
(43) Pub. Date: Dec. 16, 2021

(54) METHOD FOR PRODUCING AQUEOUS PIGMENT DISPERSION

(71) Applicant: DIC Corporation, Tokyo (JP)

(72) Inventors: Kohei Hayakawa, Kitaadachi-gun (JP); Kenji Sugo, Kitaadachi-gun (JP); Yoshihiro Sato, Kitaadachi-gun (JP); Yutaro Ueda, Kitaadachi-gun (JP); Hiroyuki Oominato, Kitaadachi-gun (JP); Shinichi Okada, Kitaadachi-gun (JP)

(73) Assignee: DIC Corporation, Tokyo (JP)

(21) Appl. No.: 17/295,175

(22) PCT Filed: Nov. 7, 2019
(86) PCT No.: PCT/JP2019/043609

§ 371 Date: May 19, 2021

(30) Foreign Application Priority Data
Nov. 22, 2018 (JP) 2018-219376

(51) Int. Cl. B01F 3/12; C09D 17/00; B01F 9/22; B04B 1/02; B04B 15/02

(52) U.S. Cl. CPC B01F 3/1214; C09D 17/003; B01F 9/22; C09D 11/322; B01F 3/1271; B04B 1/02; B04B 15/02; C09D 17/001

(57) ABSTRACT

The problem to be solved by the present invention is to provide a method for producing an aqueous pigment dispersion that has certain dispersion stability with which the formation of coarse particles with time and the settling of a pigment and the like with time can be reduced and that can be used for producing an ink having excellent discharge stability. The present invention relates to a method for producing an aqueous pigment dispersion, the method including kneading a composition including a pigment including one or more materials selected from the group consisting of a violet pigment, a green pigment, and an orange pigment and a resin, the composition having a nonvolatile content of 50% by mass or more, under predetermined conditions and subsequently performing a centrifugation treatment.

### TECHNICAL FIELD

The present invention relates to a method for producing an aqueous pigment dispersion that can be used for producing inks and the like.

### BACKGROUND ART

An ink-jet printing method has been used in the production of various types of printed matter. An ink-jet printing method is commonly a method in which an ink is discharged from a discharge nozzle and impinged onto the surface of a recording medium, such as a paper sheet or a fabric sheet, in order to produce printed matter. Thus, the ink has been required to have certain discharge stability with which the clogging of the discharge nozzle with time, a change in the volume of the ink discharged from the discharge nozzle with time, and a change in the direction in which the ink is discharged from the discharge nozzle with time can be reduced.

The ink-jet printing ink is commonly produced by feeding, as needed, a binder resin, a water-soluble solvent, an aqueous medium, and the like to an aqueous pigment dispersion, which is prepared by dispersing a pigment in an aqueous medium, and subsequently mixing the above components with one another. Therefore, for enhancing the discharge stability of the ink, it is important to use an aqueous pigment dispersion capable of reducing the formation of coarse particles, which may cause the clogging of a discharge nozzle, and the settling of the pigment and the like with time.

Examples of known aqueous pigment dispersions capable of reducing the formation of coarse particles and the settling of a pigment and the like with time include an aqueous pigment dispersion produced using a solid or semi-solid kneaded material prepared by kneading a mixture including at least a resin having an anionic group, a pigment, and a basic compound with a closed kneading apparatus (see, for example, PTL 1).

A miniaturized, high-density ink discharge nozzle that can be used for producing high-definition printed matter is likely to become clogged and cause abnormal discharge of ink due to the impact of coarse particles and sediments that are present in an ink in trace amounts. This may result in the formation of streaks or the like on printed matter.

In particular, a single-pass ink-jet printing method in which a line head is used is commonly likely to cause the degradation of image quality due to the clogging of a discharge nozzle or the like, compared with a “multi-pass” (scanning) ink-jet printing method.

As described above, although reducing the formation of coarse particles and sediments in the ink with time, which may cause the clogging and the like of a miniaturized ink discharge nozzle that can be used for producing high-definition printed matter, in an effective manner has been requested in the industrial community, the technologies known in the related art have been one step away from the required performance in some cases.

Known examples of pigments included in the aqueous pigment dispersion are violet, orange, and green pigments, in addition to yellow, magenta, cyan, and black pigments, which are referred to as “fundamental colors”.

A known example of the violet pigment is C.I. Pigment Violet 23. This pigment is likely to cause the desorption of a pigment dispersant, such as a styrene-acrylic acid pigment dispersing resin, compared with the fundamental color pigments. Thus, when an ink including C.I. Pigment Violet 23 which is known in the related art is left to stand for about one week and then discharged using an ink-jet printing apparatus, anomalies of the direction in which the ink is discharged, the clogging of a discharge nozzle, and the like may occur.

A known example of the orange pigment is C.I. Pigment Orange 43. Since this pigment is relatively hydrophobic compared with the fundamental color pigments, it cannot be dispersed in an aqueous medium in a stable manner and may form sediments with time.

A known example of the green pigment is C.I. Pigment Green 36. Since this pigment has a relatively high specific gravity compared with other pigments, it cannot be dispersed in an aqueous medium in a stable manner and may form sediments with time. Furthermore, since C.I. Pigment Green 36 is relatively likely to increase the viscosity of an ink, when the ink is used in an ink-jet recording method, anomalies of the direction in which the ink is discharged may occur.

As described above, the dispersibility and preservation stability of an ink and an aqueous pigment dispersion used for producing the ink commonly result from the type of pigment and the interaction between the pigment and a dispersing resin. Thus, using pigment dispersing resins used for producing fundamental color pigment dispersions in combination with the special color pigments does not always enable suitable dispersibility to be achieved. Therefore, enhancing the dispersibility of special color pigment dispersions may require persons skilled in the art to take a lot of trial and error.

### CITATION LIST

### Patent Literature

PTL 1: Japanese Unexamined Patent Application Publication No. 2003-226832

### SUMMARY OF INVENTION

### Technical Problem

The problem to be solved by the present invention is to provide a method for producing an aqueous pigment dispersion that has a certain degree of dispersion stability with which the formation of coarse particles with time and the settling of a pigment and the like with time can be reduced and that can be used for producing an ink having excellent discharge stability.

### Solution to Problem

The inventor of the present invention solved the above problem by using a method for producing an aqueous pigment dispersion, the method including a step [1] of kneading a composition (a1) including a pigment including one or more materials selected from the group consisting of a violet pigment, a green pigment, and an orange pigment and a resin, the composition (a1) having a nonvolatile content of 50% by mass or more, to produce a kneaded material (a2); a step [2] of mixing at least the kneaded material (a2) and an aqueous medium with each other to produce a composition (a3); and a step [3] of subjecting the composition (a3) to a centrifugation treatment at 30° C. to 70° C.

### Advantageous Effects of Invention

An aqueous pigment dispersion produced by the production method according to the present invention has certain dispersion stability with which, even when a pigment including one or more materials selected from the group consisting of a violet pigment, a green pigment, and an orange pigment is used, the formation of coarse particles and sediments with time can be reduced. The aqueous pigment dispersion can be suitably used for producing ink-jet printing inks having excellent discharge stability.

### DESCRIPTION OF EMBODIMENTS

A method for producing an aqueous pigment dispersion according to the present invention includes a step [1] of kneading a composition (a1) including a pigment including one or more materials selected from the group consisting of a violet pigment, a green pigment, and an orange pigment and a resin, the composition (a1) having a nonvolatile content of 50% by mass or more, to produce a kneaded material (a2); a step [2] of mixing at least the kneaded material (a2) and an aqueous medium with each other to produce a composition (a3); and a step [3] of subjecting the composition (a3) to a centrifugation treatment at 30° C. to 70° C.

### (Description of Step [1])

The step [1] is a step of kneading a composition (a1) including a pigment including one or more materials selected from the group consisting of a violet pigment, a green pigment, and an orange pigment and a resin, the composition (a1) having a nonvolatile content of 50% by mass or more, to produce a kneaded material (a2).

The composition (a1) may include a pigment, a resin, and optional components, such as a basic compound, a solvent such as an aqueous medium, a pigment derivative, and a surfactant, as needed.

The nonvolatile content of the composition (a1) used in the step [1] is preferably 50% by mass or more, is more preferably 50% to 90% by mass, and is particularly preferably 50% to 85% by mass.

The term “nonvolatile content” used herein refers to a value calculated on the basis of the formula [Mass¹/Mass⁰]×100, where Mass' is the mass of a component that remains after about 1 g of the composition (a1) has been heated at 175° C. for 4 hours at a reduced pressure of 3 hPa, and Mass⁰ is the mass of the composition (a1) measured before it is heated.

The use of the composition (a1) having a nonvolatile content of 50% by mass or more enables the viscosity of the kneaded material (a2) to be maintained at an adequate level during kneading and increases the shear force applied to the kneaded material (a2) by a kneading apparatus. This enables the pulverization of aggregates of the pigment and the adsorption of the resin to the pigment to be performed simultaneously in an efficient manner. As a result, an aqueous pigment dispersion that can be used for producing an ink having excellent dispersion stability, with which both formation of coarse particles with time and settling of the pigment and the like with time can be reduced, and excellent discharge stability can be produced.

### (Pigment)

Examples of pigments that can be used for producing the composition (a1) include a pigment including one or more materials selected from the group consisting of a violet pigment, a green pigment, and an orange pigment. The above pigments may be used alone or in combination of two or more. The above pigments may be used in combination with pigments other than the above pigments (e.g., yellow, magenta, cyan, and black pigments).

Examples of the violet pigment include C.I. Pigment Violet 1, 3, 5:1, 16, 19, 23, and 38. C.I. Pigment Violet 23 is preferably used in order to further enhance both color forming property and lightfastness.

C.I. Pigment Violet 23 is an ink-jet pigment that is excellent in terms of color forming property and lightfastness and assists the fundamental four colors of black, cyan, magenta, and yellow.

It is preferable to use a violet pigment, such as C.I. Pigment Violet 23, having an average particle size of 200 nm or less which is measured by electron microscopy. It is more preferable to use a violet pigment having an average particle size of 100 nm or less in order to produce an aqueous pigment dispersion having excellent discharge stability which can be used for producing high-gloss printed matter.

In the case where an aqueous violet pigment dispersion is produced as an aqueous pigment dispersion, the amount of the violet pigment used is preferably 60% to 99% by mass and is more preferably 80% to 99% by mass of the total amount of the pigment.

Examples of the green pigment include C.I. Pigment Green 1, 4, 7, 8, 10, 17, 18, 36, 50, 58, and 76. C.I. Pigment Green 36 is preferably used in order to further enhance color forming property.

It is preferable to use C.I. Pigment Green 36 having a primary particle size of 150 nm or less. It is more preferable to use C.I. Pigment Green 36 having a primary particle size of 10 to 100 nm. It is most preferable to use C.I. Pigment Green 36 having a primary particle size of 10 to 70 nm. In the measurement of primary particle size, a particle size measured using a transmission electron microscope (TEM) or the like may be used.

In the case where an aqueous green pigment dispersion is produced as an aqueous pigment dispersion, the amount of the green pigment used is preferably 60% to 99% by mass and is more preferably 80% to 99% by mass of the total amount of the pigment.

Examples of the orange pigment include orange pigments such as C.I. Pigment Orange 5, 13, 16, 17, 34, 36, 43, 51, 64, and 71. It is preferable to use Pigment Orange 34 or 43 in order to produce high-chroma printed matter having suitable lightfastness.

It is preferable to use an orange pigment of C.I. Pigment Orange 34 having a primary particle size of 100 nm or less in order to achieve a certain degree of dispersibility comparable to that of inks and aqueous pigment dispersions of the fundamental colors and a certain degree of preservation stability with which changes in physical properties with time can be reduced. It is preferable to use an orange pigment of C.I. Pigment Orange 34 having a primary particle size of 30 to 100 nm. It is more preferable to use an orange pigment of C.I. Pigment Orange 34 having a primary particle size of 40 to 80 nm in order to further enhance preservation stability.

It is preferable to use an orange pigment of C.I. Pigment Orange 43 having a primary particle size of 150 nm or less in order to achieve a certain degree of dispersibility comparable to that of inks and aqueous pigment dispersions of the fundamental colors and a certain degree of preservation stability with which changes in physical properties with time can be reduced. It is preferable to use an orange pigment, such as C.I. Pigment Orange 43, having a primary particle size of 50 to 130 nm. It is more preferable to use an orange pigment having a primary particle size of 65 to 120 nm in order to further enhance preservation stability. Note that the above primary particle sizes were measured with the device described below under the following conditions.

First, a mixture of 1 part by mass of the pigment (A) and 99 parts by mass of ethanol was dropped onto a mesh with a collodion membrane and then dried to form a test sample.

Subsequently, 1000 particles randomly selected from the test sample were observed with a scanning transmission electron microscope (STEM, JSM-7500FA, produced by JEOL Ltd., accelerating voltage: 30 kv). The average major axis length was used as a primary particle size.

The particle sizes of the violet, green, and orange pigments are preferably adjusted to fall within the respective ranges by performing dry pulverization, wet pulverization, solvent salt milling, or the like. Since metal beads are used in dry pulverization and wet pulverization, there is a high risk of inclusion of a metal as an impurity. Therefore, among the above-described methods, solvent salt milling, in which the risk of inclusion of metals is low, is preferably used.

Solvent salt milling is a method in which a mixture including at least a crude pigment, an inorganic salt, and an organic solvent is kneaded and ground with a kneading machine, such as a kneader, a two-roll mill, a three-roll mill, TRI-MIX, or ATTRITOR.

The inorganic salt that can be used in the solvent salt milling method is preferably a water-soluble inorganic salt. Sodium chloride, potassium chloride, sodium sulfate, and the like are preferably used. The inorganic salt is more preferably an inorganic salt having a primary particle size of 0.5 to 50 μm. The amount of the inorganic salt used is preferably 3 to 20 parts by mass and is more preferably 5 to 15 parts by mass relative to 1 part by mass of the crude pigment.

The organic solvent that can be used in the solvent salt milling method is preferably an organic solvent capable of suppressing crystal growth. A water-soluble organic solvent can be suitably used as such an organic solvent. For example, diethylene glycol, glycerin, ethylene glycol, propylene glycol, liquid polyethylene glycol, liquid polypropylene glycol, 2-(methoxymethoxy)ethanol, 2-butoxyethanol, 2-(isopentyloxy)ethanol, 2-(hexyloxy)ethanol, diethylene glycol monomethyl ether, diethylene glycol monoethyl ether, diethylene glycol monobutyl ether, triethylene glycol, triethylene glycol monomethyl ether, 1-methoxy-2-propanol, 1-ethoxy-2-propanol, dipropylene glycol, dipropylene glycol monomethyl ether, dipropylene glycol monomethyl ether, and dipropylene glycol can be used.

The amount of the organic solvent is preferably 0.01 to 5 parts by mass relative to 1 part by mass of the crude pigment.

The temperature at which kneading and grinding are performed in the solvent salt milling method is preferably 30° C. to 150° C. The amount of time during which kneading and grinding are performed is preferably 2 to 20 hours.

A mixture including a pigment having a primary particle size of 150 nm or less, the inorganic salt, and the organic solvent can be produced by the above-described method. When the above mixture is used to produce the aqueous pigment dispersion and ink according to the present invention, the inorganic salt and the organic solvent may be removed by washing and filtration as needed, and drying and pulverization may be subsequently performed.

In the washing and filtration step, either cold-water or hot-water washing may be used. Alternatively, washing may be performed using an acid, an alkali, or a solvent such that the crystalline state of the pigment does not change. The washing treatment may be repeatedly performed 1 to 5 times. In the case where the inorganic salt used and the organic solvent used are a water-soluble inorganic salt and a water-soluble organic solvent, the water-soluble inorganic salt and the water-soluble organic solvent can be readily removed by the washing treatment.

In the drying step, a batch or continuous drying method in which, for example, the temperature is increased to 80° C. to 120° C. using a heat source disposed in a drying machine in order to remove water and/or solvent from the pigment may be conducted. Examples of the drying machine include a box drying machine, a band drying machine, and a spray dryer.

The pulverization step is not a step conducted to increase the specific surface area of the pigment or further reduce the primary particle size of the pigment, but a step that may be conducted to disintegrate, for example, the pigment present in the form of lumps or the like when the box drying machine or the band drying machine is used, into a powder.

In the pulverization step, a mortar, a juicer, a hammer mill, a disc mill, a pin mill, a jet mill, and the like may be used.

The amount of the pigment produced by the solvent salt milling method is preferably 70 to 100 parts by mass relative to the total amount of the pigment in order to produce an aqueous pigment dispersion having further excellent preservation stability. It is more preferable to set the amount of the pigment produced by the solvent salt milling method to be close to 100 parts by mass.

In the present invention, pigments including the violet, green, or orange pigment and a pigment other than the violet, green, or orange pigment in a combined manner as needed may be used.

Examples of the other pigment include inorganic pigments, such as iron oxide, carbon black produced by a known method, such as a contact method, a furnace method, or a thermal method, and titanium oxide; and organic pigments, such as an azo pigment, (including an insoluble azo pigment, such as a monoazo pigment, a disazo pigment, or a pyrazolone pigment, a benzimidazolone pigment, a beta naphthol pigment, a naphthol AS pigment, a condensed azo pigment, and the like), a polycyclic pigment (e.g., a quinacridone pigment, a perylene pigment, a perinone pigment, an anthraquinone pigment, a dioxazine pigment, a thioindigo pigment, an isoindolinone pigment, an isoindoline pigment, a quinophthalone pigment, or a diketopyrrolopyrrole pigment), a phthalocyanine pigment, a dye chelate (e.g., a basic dye chelate or an acidic dye chelate), a nitro pigment, a nitroso pigment, and aniline black. The above pigments may be used alone or in combination of two or more.

Examples of the pigment include the following carbon black materials: No. 2300, No. 2200B, No. 995, No. 990, No. 900, No. 960, No. 980, No. 33, No. 40, No, 45, No. 45L, No. 52, HCF88, MA7, MA8, and MA1000 produced by Mitsubishi Chemical Corporation; Raven5750, Raven5250, Raven5000, Raven3500, Raven1255, and Raven700 produced by Columbia; Regal 400R, Regal 330R, Regal 660R, Mogul L, Mogul 700, Monarch800, Monarch880, Monarch900, Monarch1000, Monarch1100, Monarch1300, and Monarch1400 produced by Cabot Corporation; and Color Black FW1, Color Black FW2, Color Black FW2V, Color Black FW18, Color Black FW200, Color Black S150, Color Black S160, Color Black S170, Printex 35, Printex U, Printex V, Printex 1400U, Special Black 6, Special Black 5, Special Black 4, Special Black 4A, NIPEX150, NIPEX160, NIPEX170, NIPEX180, NIPEX95, NIPEX90, NIPEX85, NIPEX80, and NIPEX75 produced by Orion Engineered Carbons.

Examples of the pigment include the following yellow pigments: C.I. Pigment Yellow 1, 2, 12, 13, 14, 16, 17, 73, 74, 75, 83, 93, 95, 97, 98, 109, 110, 114, 120, 128, 129, 138, 150, 151, 154, 155, 174, 180, and 185.

Examples of the pigment include the following magenta pigments: C.I. Pigment Red 5, 7, 12, 48(Ca), 48(Mn), 57(Ca), 57:1, 112, 122, 123, 146, 149, 150, 168, 176, 184, 185, 202, 209, 213, 269, and 282.

Examples of the pigment include the following cyan pigments: C.I. Pigment Blue 1, 2, 3, 15, 15:1, 15:2, 15:3, 15:4, 15:6, 16, 22, 60, 63, and 66.

The pigment may be used in the form of a dry powder or a wet cake. The pigment may be a mixture or a solid solution of two or more pigments.

The amount of the pigment used is preferably 30% to 80% by mass of the total amount of the composition (a1). It is particularly preferable to use the pigment in an amount that is 35% to 75% by mass of the total amount of the composition (a1) in order to maintain the viscosity of the kneaded material (a2) at an adequate level, to increase the shear force applied to the kneaded material (a2) by a kneading apparatus, to thereby enable the pulverization of aggregates of the pigment and the adsorption of the resin to the pigment to be performed simultaneously in an efficient manner, and to consequently produce an aqueous pigment dispersion that can be used for producing an ink having excellent dispersion stability, with which both formation of coarse particles with time and settling of the pigment and the like with time can be reduced, and excellent discharge stability.

### (Resin)

Examples of the resin that can be used for producing the composition (a1) include a pigment dispersing resin. Pigment dispersing resins known in the related art may be used. For example, a radical polymer may be used. It is preferable to use a radical polymer having an aromatic ring structure or a heterocyclic structure. It is more preferable to use a radical polymer having an acid value of 60 to 300 mgKOH/g in order to produce an aqueous pigment dispersion that has certain dispersion stability with which the formation of coarse particles with time and the settling of the pigment and the like with time can be reduced and that can be used for producing an ink having excellent discharge stability.

In the case where the pigment dispersing resin is a radical polymer having an anionic group, it is preferable to use a (neutralized) radical polymer the anionic group of which has been partially or completely neutralized with a basic compound, which is described below, in order to produce an aqueous pigment dispersion that has certain dispersion stability with which the formation of coarse particles with time and the settling of the pigment and the like with time can be reduced and that can be used for producing an ink having excellent discharge stability.

Examples of the aromatic ring structure or heterocyclic structure include a ring structure introduced to the radical polymer as a result of using a monomer having an aromatic ring structure or a monomer having a heterocyclic structure, which is described below.

The aromatic ring structure is preferably a benzene ring structure and is more preferably a structure derived from styrene.

The use of a pigment dispersing resin that is the radical polymer having an aromatic ring structure or heterocyclic structure enhances the adsorption of the pigment dispersing resin to the pigment. This enables the efficient production of an aqueous pigment dispersion that has certain dispersion stability with which the formation of coarse particles with time and the settling of the pigment and the like with time can be reduced and that can be used for producing an ink having excellent discharge stability.

It is particularly preferable to use a pigment dispersing resin having an acid value of 60 to 300 mgKOH/g in order to enhance the adsorption of the pigment dispersing resin to the pigment and to consequently produce an aqueous pigment dispersion that can be used for producing an ink having excellent dispersion stability, with which both formation of coarse particles with time and settling of the pigment and the like with time can be reduced, and excellent discharge stability. Specifically, a pigment dispersing resin having an acid value that falls within the above range is likely to partially or completely dissolve in the water-soluble organic solvent, which is described below, or become swollen with the water-soluble organic solvent in the step [1] and is therefore likely to combine with the basic compound described below to form a salt (product of neutralization). When such a pigment dispersing resin is adsorbed on the pigment, the hydrophilicity of the pigment is markedly enhanced and, consequently, an aqueous pigment dispersion that can be used for producing an ink having further excellent dispersion stability and further excellent discharge stability may be produced.

The acid value is an acid value derived from anionic groups, such as a carboxyl group, a sulfo group, and a phosphate group. The acid value is preferably 80 to 250 mgKOH/g and is particularly preferably 100 to 200 mgKOH/g in order to produce an aqueous pigment dispersion that has certain dispersion stability with which the formation of coarse particles with time and the settling of the pigment and the like with time can be reduced and that can be used for producing an ink having excellent discharge stability.

The acid value is the value measured in accordance with Japanese Industrial Standard “K0070:1992. Test methods for acid value, saponification value, ester value, iodine value, hydroxyl value and unsaponifiable matter of chemical products” except that tetrahydrofuran is used instead of diethyl ether as a solvent. The acid value indicates the amount (mg) of potassium hydroxide necessary to completely neutralize 1 g of the resin.

Examples of the radical polymer that can be used as a pigment dispersing resin include a polymer produced by radical polymerization of a monomer.

In the case where an aromatic ring structure is to be introduced to the pigment dispersing resin, the monomer may be a monomer having an aromatic ring structure. In the case where a heterocyclic structure is to be introduced to the pigment dispersing resin, the monomer may be a monomer having a heterocyclic structure.

Examples of the monomer having an aromatic ring structure include styrene, p-tert-butyldimethylsiloxystyrene, o-methylstyrene, p-methylstyrene, p-tert-butylstyrene, p-tert-butoxystyrene, m-tert-butoxystyrene, p-tert-(1-ethoxymethyl)styrene, m-chlorostyrene, p-chlorostyrene, p-fluorostyrene, α-methylstyrene, p-methyl-α-methylstyrene, vinylnaphthalene, and vinylanthracene.

Examples of the monomer having a heterocyclic structure include vinylpyridine monomers, such as 2-vinylpyridine and 4-vinylpyridine.

In the case where a radical polymer having both aromatic ring structure and heterocyclic structure is used, the monomer having an aromatic ring structure and the monomer having a heterocyclic structure may be used in combination with each other.

Since it is preferable to use a radical polymer having an aromatic ring structure as a pigment dispersing resin in the present invention, it is preferable to use the monomer having an aromatic ring structure. It is more preferable to use styrene, α-methylstyrene, or tert-butylstyrene.

The amount of the monomer having an aromatic ring structure or a heterocyclic structure is preferably 20% by mass or more, is more preferably 40% by mass or more, and is further preferably 95% by mass or less of the total amount of the monomers in order to further enhance the adsorption of the pigment dispersing resin to the pigment.

A monomer including an anionic group may be used in order to produce, as a pigment dispersing resin, a radical polymer having an acid value that falls within the specific range described above.

Examples of the monomer including an anionic group include monomers including an anionic group, such as a carboxyl group, a sulfo group, or a phosphate group.

It is preferable to use a monomer including a carboxyl group which is readily available as a monomer including an anionic group in order to produce an aqueous pigment dispersion that has certain dispersion stability with which the formation of coarse particles with time and the settling of the pigment and the like with time can be reduced and that can be used for producing an ink having excellent discharge stability. It is more preferable to use acrylic acid or methacrylic acid.

The amount of the monomer including an anionic group is preferably 5% to 80% by mass of the total amount of the monomers that can be used for producing the pigment dispersing resin. The proportion of the amount of the monomer including an anionic group is more preferably 5% to 60% by mass in order to produce a radical polymer having an acid value that falls within the above predetermined range.

For producing the pigment dispersing resin, monomers other than the above-described monomers may be used as needed.

Examples of the other monomers include methyl (meth)acrylate, n-propyl (meth)acrylate, isopropyl (meth)acrylate, n-butyl (meth)acrylate, sec-butyl (meth)acrylate, tert-butyl (meth)acrylate, 2-ethylbutyl (meth)acrylate, 1,3-dimethylbutyl (meth)acrylate, hexyl (meth)acrylate, 2-ethylhexyl (meth)acrylate, octyl (meth)acrylate, ethyl (meth)acrylate, n-butyl (meth)acrylate, 2-methylbutyl (meth)acrylate, pentyl (meth)acrylate, heptyl (meth)acrylate, nonyl (meth)acrylate, 3-ethoxypropyl (meth)acrylate, 3-ethoxybutyl (meth)acrylate, dimethylaminoethyl (meth)acrylate, 2-hydroxyethyl (meth)acrylate, 2-hydroxybutyl (meth)acrylate, ethyl-α-(hydroxymethyl) (meth)acrylate, dimethylaminoethyl (meth)acrylate, hydroxyethyl (meth)acrylate, hydroxypropyl (meth)acrylate, phenyl (meth)acrylate, benzyl (meth)acrylate, phenylethyl (meth)acrylate, diethylene glycol (meth)acrylate, triethylene glycol (meth)acrylate, polyethylene glycol (meth)acrylate, glycerin (meth)acrylate, bisphenol A (meth)acrylate, dimethyl maleate, diethyl maleate, and vinyl acetate. The above monomers may be used alone or in combination of two or more. Note that the term “(meth)acrylate” used herein refers to an acrylate or a methacrylate. Thus, in the practical application, the acrylate ester monomers may be used alone or in a mixture at any ratio.

As a pigment dispersing resin, a polymer having a linear structure formed by the radical polymerization of the monomers, a polymer having a grafted structure formed by the radical polymerization of the monomers, and a polymer having a crosslinked structure formed by the radical polymerization of the monomers may be used. In each of the above polymers, the arrangement of the monomers is not limited; a random polymer and a block polymer may be used.

The polymer including a crosslinked structure can be produced using a monomer including a crosslinkable functional group.

Examples of the monomer including a crosslinkable functional group include poly(meth)acrylates of a polyhydric alcohol, such as ethylene glycol di(meth)acrylate, propylene glycol di(meth)acrylate, polyethylene glycol di(meth)acrylate, poly(oxyethylene oxypropylene) glycol di(meth)acrylate, and tri(meth)acrylate of an alkylene oxide adduct of glycerin; and glycidyl (meth)acrylate and divinylbenzene.

Although the pigment dispersing resin used in the present invention may be a polymer of the above-described monomers, it is preferable to use a polymer produced by polymerization of only the monomer including an anionic group and the monomer including an aromatic ring structure or a heterocyclic structure.

Among the above-described polymers, a polymer including a styrene structural unit and a (meth)acrylic acid structural unit, such as a styrene-(meth)acrylic acid copolymer or a styrene-(meth)acrylate ester-(meth)acrylic acid polymer, is preferably used as a pigment dispersing resin in the present invention. Among such polymers, a polymer having an acid value that falls within the preferable range described above is preferably used in order to produce an aqueous pigment dispersion that has certain dispersion stability with which the formation of coarse particles with time and the settling of the pigment and the like with time can be reduced with further effect and that can be used for producing an ink having excellent discharge stability.

Although the styrene-(meth)acrylic acid copolymer may be any of a styrene-acrylic acid copolymer, a styrene-methacrylic acid copolymer, and a styrene-acrylic acid-methacrylic acid copolymer, it is preferable to use a styrene-acrylic acid-methacrylic acid copolymer in order to enhance the copolymerizability of the monomers and consequently produce an aqueous pigment dispersion that has certain dispersion stability with which the formation of coarse particles with time and the settling of the pigment and the like with time can be reduced with further effect and that can be used for producing an ink having excellent discharge stability.

It is preferable to use a styrene-(meth)acrylic acid copolymer such that the total amount of styrene, acrylic acid, and methacrylic acid is 80% to 100% by mass of the total amount of the monomers used for producing the styrene-(meth)acrylic acid copolymer. It is further preferable to use a styrene-(meth)acrylic acid copolymer such that the above proportion is 90% to 100% by mass.

The radical polymer can be produced by, for example, performing radical polymerization of the above monomers using bulk polymerization, solution polymerization, suspension polymerization, emulsion polymerization, or the like.

In the production of the radical polymer, a polymerization initiator, a chain-transfer agent (polymerization degree modifier), a surfactant, and an antifoaming agent which are known and commonly used in the related art may be used as needed.

Examples of the polymerization initiator include 2,2′-azobis(2,4-dimethyl)valeronitrile), 2,2′-azobisisobutyronitrile, 1,1′-azobis(cyclohexane-1-carbonitrile), benzoyl peroxide, dibutyl peroxide, and butyl peroxybenzoate. The amount of the polymerization initiator used is preferably 0.1% to 10% by mass of the total amount of the monomers used for producing the radical polymer.

The weight-average molecular weight of the pigment dispersing resin used is preferably 2000 to 40000, is more preferably 5000 to 30000, and is particularly preferably 5000 to 20000 in order to produce an aqueous pigment dispersion that can be used for producing an ink having further excellent dispersion stability, with which the formation of coarse particles with time and the settling of the pigment and the like with time can be reduced, and excellent discharge stability.

The above weight-average molecular weight is measured by GPC (gel permeation chromatography) in terms of the molecular weight of polystyrene used as a reference substance.

In the case where a radical polymer produced by the solution polymerization method is used as a pigment dispersing resin, a resin produced by removing a solvent included in a radical polymer solution prepared by the solution polymerization method and subsequently performing drying and pulverization to form microparticles may be used as a pigment dispersing resin.

A pigment dispersing resin that is a radical polymer present in the form of microparticles is likely to partially or completely dissolve in the water-soluble organic solvent, which is described below, or become swollen with the water-soluble organic solvent in the step [1] and is therefore likely to adsorb to the pigment. This enables the production of an aqueous pigment dispersion that can be used for producing an ink having further excellent dispersion stability and further excellent discharge stability.

The pigment dispersing resin may be classified through a mesh-like sieve. It is preferable to use a pigment dispersing resin having a particle size of about 1 mm or less.

The weight ratio of the pigment dispersing resin to the pigment in the composition (a1) used is preferably 5% to 200% by mass and is more preferably 10% to 100% by mass in order to make it possible to knead the kneaded material (a2) at an adequate viscosity in the step [1], to enable the pigment dispersing resin to readily adsorb to the pigment, and to consequently produce an aqueous pigment dispersion that can be used for producing an ink having excellent dispersion stability, with which both formation of coarse particles with time and settling of the pigment and the like with time can be reduced, and excellent discharge stability.

As for the resin that can be used in the present invention, a binder resin and the like may be optionally used in addition to the pigment dispersing resin.

The composition (a1) used in the step [1] may optionally include a basic compound in addition to the pigment and the pigment dispersing resin.

In the case where the pigment dispersing resin includes an anionic group, the basic compound neutralizes the anionic group. The neutralization of the pigment dispersing resin with the basic compound increases the affinity of the pigment on which the pigment dispersing resin is adsorbed for an aqueous medium. This enables the pigment particles to be dispersed in the aqueous pigment dispersion in a further stable manner and consequently reduces the formation of coarse particles with time and the settling of the pigment and the like with time in a further effective manner.

Examples of the basic compound include an inorganic basic compound and an organic basic compound.

Basic compounds known in the related art may be used. Examples of such basic compounds include the following inorganic basic compounds: hydroxides of an alkali metal, such as potassium or sodium; carbonate salts of an alkali metal, such as potassium or sodium; carbonate salts of an alkaline-earth metal or the like, such as calcium or barium; and ammonium hydroxide. Examples of such basic compounds further include the following organic basic compounds: amino alcohols, such as triethanolamine, N,N-dimethanolamine, N-ethylethanolamine, dimethylethanolamine, and N-butyldiethanolamine; morpholines, such as morpholine, N-methylmorpholine, and N-ethylmorpholine; and piperazines, such as N-(2-hydroxyethyl)piperazine and piperazine hexahydrate. In particular, it is preferable to use an alkali metal hydroxide, such as potassium hydroxide, sodium hydroxide, or lithium hydroxide, as a basic compound in order to increase the efficiency with which the pigment dispersing resin is neutralized and thereby enhance the dispersion stability of the pigment on which the pigment dispersing resin is adsorbed in an aqueous medium. It is particularly preferable to use potassium hydroxide.

In the case where the pigment dispersing resin includes an anionic group, it is preferable to use the basic compound such that the ratio of neutralization of the pigment dispersing resin falls within a range of 80% to 120% in order to increase the affinity of the neutralized pigment dispersing resin for an aqueous medium and thereby enhance the stability with which the pigment including the pigment dispersing resin adsorbed thereon is dispersed in water.

Neutralization ratio (%)=((Mass of basic compound (g)×56×1000)/(Acid value of pigment dispersing resin×Equivalent weight of basic compound×Mass of pigment dispersing resin (g)))×100

The composition (a1) used in the step [1] may optionally include a solvent, such as a water-soluble organic solvent or an aqueous medium, as needed in addition to the above-described components.

The water-soluble organic solvent is likely to dissolve or swell a part or the entirety of the pigment dispersing resin in the step [1] and consequently enables the pigment dispersing resin to readily adsorb to the pigment. This enables the production of an aqueous pigment dispersion that can be used for producing an ink having further excellent dispersion stability and further excellent discharge stability.

Examples of the water-soluble organic solvent include glycols, such as ethylene glycol, diethylene glycol, triethylene glycol, tetraethylene glycol, propylene glycol, polyethylene glycol, and polypropylene glycol; diols, such as butanediol, pentanediol, and hexanediol; glycol esters, such as propylene glycol laurate; diethylene glycol ethers, such as diethylene glycol monoethyl, diethylene glycol monobutyl, diethylene glycol monohexyl, and carbitol; glycol ethers such as cellosolve, including propylene glycol ether, dipropylene glycol ether, and triethylene glycol ether; alcohols, such as methanol, ethanol, isopropyl alcohol, 1-propanol, 2-propanol, 1-butanol, 2-butanol, butyl alcohol, and pentyl alcohol; and various types of other solvents known as aqueous organic solvents, such as a lactone (e.g., sulfolane, ester, ketone, or γ-butyrolactone, a lactam (e.g., N-(2-hydroxyethyl)pyrrolidone), and glycerin and a polyalkylene oxide adduct thereof. The above aqueous organic solvents may be used alone or in combination of two or more.

Among the above water-soluble organic solvents, polyalcohols and glycerin derivatives are preferably used since they are solvents having a high boiling point and low volatility, which can be used as a humectant, in addition to a high surface tension. It is particularly preferable to use a glycol, such as diethylene glycol or triethylene glycol, or a polyoxyalkylene adduct of glycerin, such as a polyethylene oxide adduct of glycerin.

The amount of the water-soluble organic solvent used in the step [1] is preferably 10% to 200% by mass and is more preferably 15% to 150% by mass of the mass of the pigment in order to produce an aqueous pigment dispersion that can be used for producing an ink having further excellent dispersion stability and further excellent discharge stability.

The composition (a1) used in the step [1] may optionally include a pigment derivative in addition to the pigment and resins such as the pigment dispersing resin.

The pigment derivative enhances the dispersion stability of the aqueous pigment dispersion according to the present invention and the dispersion stability of an ink produced using the aqueous pigment dispersion, with which the formation of coarse particles with time and the settling of the pigment and the like with time can be reduced.

The pigment derivative may be produced by introducing the specific functional group described below to a pigment. Examples of the above pigment include a phthalocyanine pigment, an azo pigment, an anthraquinone pigment, a quinacridone pigment, and a diketopyrrolopyrrole pigment. Examples of the above functional group include a carboxyl group, a sulfo group, an amino group, a nitro group, an acid amide group, a carbonyl group, a carbamoyl group, a phthalimide group, and a sulfonyl group.

The water constituting a part or the entirety of the solvent may be pure water, such as ion-exchange water, ultrafiltration water, reverse osmosis water, or distilled water, or ultrapure water. It is suitable to use water sterilized by ultraviolet irradiation, addition of hydrogen peroxide, or the like in order to prevent the growth of mold and bacteria which may occur during a long-term storage of the aqueous pigment dispersion, an ink produced using the aqueous pigment dispersion, or the like.

Examples of a kneading machine that can be used for kneading the composition (a1) in the step [1] include Henschel mixer, a pressure kneader, Banbury mixer, TRI-MIX, and a planetary mixer. It is particularly preferable to use a planetary mixer as a kneading machine in order to apply a large shear force to the composition (a1) having a nonvolatile content of 50% by mass or more and thereby increase ease of the pulverization of aggregates of the pigment and the adsorption of the pigment dispersing resin to the pigment.

The planetary mixer is preferable because it is capable of increasing ease of the pulverization of aggregates of the pigment and the adsorption of the pigment dispersing resin to the pigment even when the viscosity of the composition (a1) varies over a wide range.

The planetary mixer is also preferable in order to conduct the step [2], in which an aqueous medium is fed to the mixer, subsequent to the termination of the step [1].

The temperature of the composition (a1) at which the composition (a1) is kneaded in the step [1] is preferably adjusted appropriately in consideration of the temperature characteristics, such as glass transition point, of the pigment dispersing resin in order to apply a sufficient shear force to the composition (a1). Specifically, the upper limit for the temperature of the composition (a1) at which kneading is performed is preferably the glass transition temperature (Tg) of the pigment dispersing resin, while the lower limit for the temperature of the composition (a1) at which kneading is performed is preferably a temperature lower than the glass transition temperature of the pigment dispersing resin by 60° C. It is preferable to knead the composition (a1) at a temperature that falls within the above temperature range in order to apply a sufficient shear force to the composition (a1) and consequently increase ease of the pulverization of aggregates of the pigment and the adsorption of the pigment dispersing resin to the pigment.

In the step [1], an increase in the temperature of the composition (a1) may result in a significant viscosity reduction. Since a reduction in the viscosity of the composition (a1) may make it impossible to apply a sufficient shear force to the composition (a1), the aqueous medium described below or the like may be used in the middle of the step [1] to cool the composition (a1) intentionally.

The glass transition temperature (Tg) of the pigment dispersing resin is a temperature calculated using the FOX equation on the basis of the glass transition temperatures of homopolymers of the monomers used for producing the pigment dispersing resin.

1/Tg=W1/Tg1+W2/Tg2+W3/Tg3 . . . +Wn/Tgn

(where Tgn's represent the glass transition temperatures (K) of homopolymers of the monomers used for producing the pigment dispersing resin; and Wn's represent the mass fractions of the monomers)

The kneading apparatus is preferably a closed kneading apparatus. The use of the closed kneading apparatus prevents the content of the water-soluble organic solvent from significantly changing in the step [1] and consequently further increases the efficiency of the production of the aqueous pigment dispersion.

The expression “significantly change” used herein refers to a state in which the ratio of the mass of the kneaded material (a2) prepared subsequent to the termination of the step [1] to the mass of the composition (a1) is reduced to less than 90% by mass.

Examples of the closed kneading apparatus include a kneading apparatus including a stirring tank and a single or multiple impellers.

It is preferable to use a closed kneading apparatus including two or more impellers in order to achieve high kneading action.

The kneaded material (a2) prepared in the step [1] includes microparticles of the pigment, which are produced by disintegrating aggregates of the pigment, and the pigment dispersing resin adsorbed thereon and is in a semi-solid or solid state at normal temperature.

### (Description of Step [2])

The step [2] constituting the method for producing an aqueous pigment dispersion according to the present invention is a step of mixing the kneaded material (a2) prepared in the step [1] with an aqueous medium and, as needed, other components to produce a composition (a3).

In the step [2], the aqueous medium, etc. may be fed to and mixed with the kneaded material (a2). Conversely, the kneaded material (a2) may be fed to and mixed with the aqueous medium, etc.

In the case where a closed kneading apparatus, such as a planetary mixer, is used in the step [1], it is preferable to feed the aqueous medium, etc. to the kneading apparatus containing the kneaded material (a2) and mix the aqueous medium, etc. with the kneaded material (a2) in order to increase the efficiency of the production of the aqueous pigment dispersion. In such a case, it is preferable to feed the aqueous medium while the kneading apparatus is operated (while the stirring of the kneaded material (a2) is continued) before the temperature of the kneaded material (a2) decreases, in order to increase the efficiency of the dispersion of the kneaded material (a2) in the aqueous medium and the efficiency of the production of the composition (a3). It is preferable to use water having a temperature of 25° C. to 65° C. as an aqueous medium in order to prevent a significant reduction in the temperature of the kneaded material (a2).

Examples of the method for feeding the aqueous medium to the kneaded material (a2) include batch feeding and continuous or intermittent feeding. It is preferable to use continuous or intermittent feeding for feeding the aqueous medium in order to disperse the kneaded material (a2) in the aqueous medium in an efficient manner and consequently reduce the amount of time required for producing the aqueous pigment dispersion.

Examples of the aqueous medium include water, a water-soluble organic solvent that is readily miscible with water, and a mixture of water and the water-soluble organic solvent. Examples of the water-soluble organic solvent are the same as those described above as examples of the water-soluble organic solvent that can be used in the step [1], and such water-soluble organic solvents may be used alone or in combination of two or more.

The composition (a3) produced by conducting the steps [1] and [2] is a liquid composition including the pigment on which the pigment dispersing resin is adsorbed and the aqueous medium in which the pigment is dispersed.

The nonvolatile content of the composition (a3) is preferably 10% to 30% by mass and is more preferably 12% to 25% by mass of the total amount of the composition (a3).

In the present invention, the composition (a3) prepared in the step [2] may be optionally subjected to a dispersion treatment using a dispersing apparatus prior to the step [3]. Examples of the dispersing apparatus include dispersers using media, such as a paint shaker, a ball mill, Attritor, a basket mill, a sand mill, a sand grinder, Dyno Mill, DISPERMAT, SC-MILL, Spike Mill, and Agitator Mill; and dispersers without media, such as an ultrasonic homogenizer, a high-pressure homogenizer, Nanomizer, Dissolver, Disper, and a high-speed impeller disperser.

In the case where the composition (a3) includes an impurity, such as a polyvalent metal ion, in the present invention, it is preferable to subject the composition (a3) prepared in the step [2] to a treatment that removes the impurity with a chelate resin prior to the step [3] as needed.

Known examples of an ink-jet printing method are a piezoelectric ink-jet printing method and a thermal ink-jet printing method. In particular, in the case where a thermal ink-jet printing method is used, a phenomenon referred to as “Cogation” in which aggregates of the resins, such as the pigment dispersing resin, and a polyvalent metal ion or aggregates of polyvalent metal salts derived from the polyvalent metal ion are deposited on the surface of a heat-generating resistance element disposed inside the nozzle may occur due to a sudden increase in the temperature of the inside of the nozzle upon the discharge of an ink. Since the aggregates may cause abnormal discharge of ink, there is a strong demand for a reduction in the content of a polyvalent metal ion in an ink-jet recording ink.

Examples of the method for reducing the content of the polyvalent metal ion include a method in which the aqueous pigment ink or the aqueous pigment dispersion is brought into contact with a particulate or fibrous resin having a chelating group in order to remove a polyvalent metal.

### (Description of Step [3])

The step [3] constituting the method for producing an aqueous pigment dispersion according to the present invention is a step of subjecting the composition (a3), which is prepared by conducting at least the steps [1] and [2], to a centrifugation treatment at 30° C. to 70° C.

Trace amounts of components responsible for the formation of the coarse particles and the like, such as unpulverized aggregates of the pigment, an undissolved pigment dispersing resin, and pigment particles on which the pigment dispersing resin is not adsorbed in a sufficient manner, may remain in the composition (a3). Therefore, a reduction in the content of such components has been studied in the industrial community.

A miniaturized, high-density ink discharge nozzle that can be used for producing high-definition printed matter is likely to become clogged and cause anomalies in the direction of ink discharge due to the impact of coarse particles and sediments that are present in an ink in trace amounts. This may cause the formation of streaks and the like on printed matter. In particular, a single-pass ink-jet printing method in which a line head is used is commonly likely to cause the degradation of image quality due to the clogging of a discharge nozzle or the like, compared with a “multi-pass” (scanning) ink-jet printing method.

In the present invention, an aqueous pigment dispersion that can be used for producing an ink that does not cause the clogging and the like of an ink discharge nozzle even when the ink is applied to an miniaturized, high-density ink discharge nozzle since the composition (a3) is subjected to a centrifugation treatment under predetermined conditions subsequent to the production of the composition (a3) was devised.

The term “coarse particle” used herein refers to a particle the diameter of which measured with a particle-counting particle size distribution analyzer (Accusizer 780 APS) produced by Particle Sizing Systems is 0.5 μm or more.

It does not mean that any centrifugation treatment may be performed in the step [3]; the centrifugation treatment is performed at 30° C. to 70° C. If the step [3] is conducted at a temperature of less than 30° C., the viscosity of the composition (a3) is increased and, consequently, it may become difficult to remove the coarse particles with efficiency to a practically sufficient degree. If the step [3] is conducted at a temperature of more than 70° C., the evaporation of water from the composition (a3) is increased, the viscosity of the composition (a3) is likely to be increased accordingly, and, consequently, it may become difficult to remove the coarse particles with efficiency to a practically sufficient degree.

In the step [3], it is more preferable to perform the centrifugation treatment at 40° C. to 65° C. in order to remove the coarse particles with efficiency to a practically sufficient degree. Note that the above temperature is the temperature of the composition (a3) that is to be subjected to the centrifugation treatment.

The temperature of the composition (a3) may be adjusted to be 30° C. to 70° C. with a heat-exchange apparatus or the like before the composition (a3) is fed to a centrifugal separation apparatus. Alternatively, in the case where a centrifugal separation apparatus having a temperature setting function is used, the temperature of the composition (a3) may be adjusted to fall within the above temperature range after the composition (a3) has been fed to the centrifugal separation apparatus.

Heating the composition (a3) reduces the viscosity of the composition (a3), thereby improves the efficiency of centrifugation, and enables the coarse particles to be removed with efficiency. Controlling the temperature of the composition (a3) to fall within the above temperature range reduces the impacts of the outside air temperature and enables an aqueous pigment dispersion that does not include a large amount of coarse particles to be produced in a consistent manner.

The viscosity of the composition (a3) at 25° C. which is subjected to the centrifugation treatment is preferably 13 mPa-s or less in order to remove the coarse particles from the composition (a3) with further efficiency to a practically sufficient degree.

In particular, in the case where the cylindrical centrifugal separation apparatus described below is used as a centrifugal separation apparatus, the viscosity of the composition (a3) at 25° C. is preferably 10.5 mPa-s or less and is more preferably 2 to 10.5 mPa-s in order to remove the coarse particles from the composition (a3) with further efficiency to a practically sufficient degree.

It is preferable to use a centrifugal separation apparatus including a cylindrical rotor in order to effectively limit a reduction in centrifugation efficiency which may be caused as a result of the sedimentation of clayey sludge including the coarse particles inside the rotor.

The composition (a3) produced by conducting the steps [1] and [2] is likely to include coarse particles having various sizes, such as coarse particles of the pigment, unpulverized pigment, and undissolved pigment dispersing resin. Conducting the step [3] using the cylindrical centrifugal separation apparatus enables the above coarse particles to be removed in an efficient and consistent manner, without impairing productivity. Consequently, it becomes possible to achieve excellent dispersion stability with which both formation of coarse particles with time and settling of the pigment and the like with time can be reduced.

The step [3] is preferably conducted while the composition (a3) is fed to a rotor included in the cylindrical centrifugal separation apparatus and the temperature of the composition (a3) is maintained at 30° C. to 70° C. in order to maintain suitable centrifugation efficiency with consistency over a prolonged period of time and thereby remove the coarse particles from the composition (a3) with further efficiency to a sufficient degree. In such a case, the ratio of the amount (volume) of the composition (a3) fed to the rotor to the volumetric capacity of the rotor, that is, [Amount (volume) of composition (a3) fed/Volumetric capacity of rotor]×100, is preferably 1000% to 8000% and is more preferably 2000% to 7000% in order to remove the coarse particles from the composition (a3) with further efficiency, while reducing the risk of the removal of particles of the components, such as the pigment, which are not coarse particles.

The centrifugal acceleration of the centrifugal separation apparatus is preferably 8000 to 20000 G and is more preferably 9000 to 20000 G in order to reduce the risk of the pigment dispersing resin detaching from the pigment and remove the coarse particles from the composition (a3) with efficiency.

The term “centrifugal acceleration” used herein refers to a relative centrifugal acceleration defined by the following formula.

Centrifugal acceleration (G)=r×(2πN/60)²/g

(where N represents the number of revolutions per minute (rpm), r represents the radius of gyration (m), g represents the gravitational acceleration (9.8 m/s²), and π represents Pi, that is, the ratio of the circumference of a circle to its diameter)

As described above, the aqueous pigment dispersion produced by conducting at least the steps [1], [2], and [3] is an aqueous pigment dispersion that has certain dispersion stability with which the formation of coarse particles with time and the settling of the pigment and the like with time can be reduced and that can be used for producing an ink having excellent discharge stability.

The above-described aqueous pigment dispersion may be used as ink after being diluted to an intended concentration.

Examples of the ink include paints for automobiles and building materials; printing inks, such as an offset ink, a gravure ink, a frexo ink, and a silk screen ink; and ink-jet printing inks.

In the case where the above ink is used as an ink-jet recording ink, the concentration of the pigment in the ink is preferably 1% to 10% by mass with respect to the total amount of ink.

The ink can be produced by mixing the aqueous pigment dispersion according to the present invention with, as needed, a solvent, such as a water-soluble organic solvent or water, a resin serving as a binder, such as an acrylic resin or a polyurethane resin, and additives, such as a drying suppressor, a penetrant, a surfactant, a preservative, a viscosity modifier, a pH control agent, a chelating agent, a plasticizer, an antioxidant, and an ultraviolet absorber. After the ink has been produced by the above-described method, it may be subjected to a centrifugation treatment or a filtration treatment.

The water-soluble organic solvent may be used to avoid the drying of the ink and adjust the viscosity and concentration of the ink to fall within the respective suitable ranges.

Examples of the water-soluble organic solvent are the same as those described above as examples of the water-soluble organic solvent that can be used in the step [1] of the aqueous pigment dispersion. Examples of an water-soluble organic solvent that particularly enhances the ability of the ink to penetrate recording media include lower alcohols, such as ethanol and isopropyl alcohol; ethylene oxide adducts of alkyl alcohols, such as ethylene glycol hexyl ether and diethylene glycol butyl ether; and propylene oxide adducts of alkyl alcohols, such as propylene glycol propyl ether.

Examples of the drying inhibitor include glycerin, ethylene glycol, diethylene glycol, triethylene glycol, triethylene glycol mono-n-butyl ether, polyethylene glycol having a molecular weight of 2000 or less, propylene glycol, dipropylene glycol, tripropylene glycol, 1,3-propylene glycol, isopropylene glycol, isobutylene glycol, 1,4-butanediol, 1,3-butanediol, 1,5-pentanediol, 1,6-hexanediol, meso-erythritol, and pentaerythritol. Among these, glycerin and triethylene glycol are particularly used as a drying inhibitor in order to produce an ink that is safe, is resistant to drying, and has excellent discharge performance.

The drying inhibitor may be the same compound as that used as a water-soluble organic solvent for producing the above-described aqueous pigment dispersion. Thus, in the case where a water-soluble organic solvent has been used for producing the aqueous pigment dispersion, the water-soluble organic solvent may serve also as a drying inhibitor.

The penetrant may be used to improve the ability of the ink to penetrate recording media and adjust dot diameter on recording media.

Examples of the penetrant include lower alcohols, such as ethanol and isopropyl alcohol; and glycol monoethers of alkyl alcohols, such as ethylene glycol hexyl ether, diethylene glycol butyl ether, and propylene glycol propyl ether. The content of the penetrant in the ink is preferably 0.01% to 10% by mass.

The surfactant may be used to adjust the properties of the ink, such as surface tension. Examples of the surfactant include, but are not limited to, various anionic surfactants, nonionic surfactants, cationic surfactants, and zwitterionic surfactants. Among these, anionic surfactants and nonionic surfactants are preferable.

Examples of the anionic surfactants include an alkylbenzenesulfonate salt, an alkylphenylsulfonate salt, an alkylnaphthalenesulfonate salt, a higher fatty acid salt, a sulfate ester salt of a higher fatty acid ester, a sulfonate salt of a higher fatty acid ester, sulfate ester salt and sulfonate salt of a higher alcohol ether, a higher alkyl sulfosuccinate salt, a polyoxyethylene alkyl ether carboxylate salt, a polyoxyethylene alkyl ether sulfate, an alkyl phosphate salt, and a polyoxyethylene alkyl ether phosphate salt. Specific examples thereof include a dodecylbenzenesulfonate salt, an isopropyl naphthalenesulfonate salt, a monobutyl phenyl phenol monosulfonate salt, a monobutyl biphenyl sulfonate salt, and a dibutyl phenyl phenol disulfonate salt.

Examples of the nonionic surfactants include a polyoxyethylene alkyl ether, a polyoxyethylene alkyl phenyl ether, a polyoxyethylene fatty acid ester, a sorbitan fatty acid ester, a polyoxyethylene sorbitan fatty acid ester, a polyoxyethylene sorbitol fatty acid ester, a glycerin fatty acid ester, a polyoxyethylene glycerin fatty acid ester, a polyglycerin fatty acid ester, a sucrose fatty acid ester, polyoxyethylene alkylamine, polyoxyethylene fatty acid amide, fatty acid alkylolamide, alkyl alkanolamide, acetylene glycol, an oxyethylene adduct of acetylene glycol, and a polyethylene glycol polypropylene glycol block copolymer. Among these, a polyoxyethylene nonylphenyl ether, a polyoxyethylene octylphenyl ether, a polyoxyethylene dodecylphenyl ether, a polyoxyethylene alkyl ether, a polyoxyethylene fatty acid ester, a sorbitan fatty acid ester, a polyoxyethylene sorbitan fatty acid ester, a fatty acid alkylolamide, acetylene glycol, an oxyethylene adduct of acetylene glycol, and a polyethylene glycol polypropylene glycol block copolymer are preferable.

Examples of other surfactants include silicone surfactants, such as a polysiloxane oxyethylene adduct; fluorine-containing surfactants, such as a perfluoroalkyl carboxylate salt, a perfluoroalkyl sulfonate salt, and an oxyethylene perfluoroalkyl ether; and biosurfactants, such as spiculisporic acid, rhamnolipid, and lysolecithin.

The above surfactants may be used alone or in combination of two or more. The amount of the surfactant used is preferably 0.001% to 2% by mass, is more preferably 0.001% to 1.5% by mass, and is further preferably 0.01% to 1% by mass of the total mass of the ink in order to reduce the bleeding and the like of printed images with further effect.

The ink prepared by the above-described method can be suitably used as an ink-jet recording ink. Examples of an ink-jet recording method include continuous spraying methods (e.g., charge-controlling type and spray type) and on-demand methods (e.g., piezoelectric type, thermal type, and electrostatic suction type). Among these, a printing method or method for producing printed matter in which a single-pass ink-jet recording method using a line head, which is commonly likely to cause the degradation of image quality due to the clogging of a discharge nozzle or the like compared with a multi-pass (scanning) ink-jet printing method, is selected and used in combination with the ink according to the present invention is preferably used in order to limit the degradation of image quality due to the clogging of a discharge nozzle or the like and produce printed matter while reducing the formation of streaks and the like on printed matter.

### EXAMPLES

The present invention is described specifically with reference to Examples below.

### (Pigment Dispersing Resin)

A polymer of 77 parts by mass of styrene, 10 parts by mass of acrylic acid, and 13 parts by mass of methacrylic acid was used as a pigment dispersing resin A (weight-average molecular weight: 11000, acid value: 150 mgKOH/g, glass transition temperature (Tg) calculated using the FOX equation on the basis of the glass transition temperatures of homopolymers: 113° C.).

A polymer of 83 parts by mass of styrene, 7 parts by mass of acrylic acid, and 10 parts by mass of methacrylic acid was used as a pigment dispersing resin B (weight-average molecular weight: 11000, acid value: 120 mgKOH/g, glass transition temperature (Tg) calculated using the above equation: 110° C.).

A polymer of 72 parts by mass of styrene, 12 parts by mass of acrylic acid, and 16 parts by mass of methacrylic acid was used as a pigment dispersing resin C (weight-average molecular weight: 11000, acid value: 180 mgKOH/g, glass transition temperature (Tg) calculated using the above equation: 116° C.).

As for the glass transition temperatures (Tg) of homopolymers of the monomers used for producing the pigment dispersing resin, the following glass transition temperatures described in POLYMER HANDBOOK THIRD EDITION (A WILEY-INTERSCIENCE PUBLICATION) were used: styrene homopolymer (Tg: 100° C.), methacrylic acid homopolymer (Tg: 228° C.), and acrylic acid homopolymer (Tg: 106° C.).

The weight-average molecular weights of the pigment dispersing resins A to C were measured by GPC (gel permeation chromatography) in terms of molecular weight of polystyrene. The measurement conditions were as follows.

Liquid feed pump: LC-9A

System controller: SLC-6B

Auto injector: SlL-6B

Detector: RID-6A

The above devices are produced by Shimadzu Corporation

Data processing software: Sic480II Data Station (produced by SYSTEM INSTRUMENTS Co., Ltd.)

Column: GL-R400 (guard column)+GL-R440+GL-R450+GL-R400M (produced by Hitachi Chemical Co., Ltd.)

Elution solvent: tetrahydrofuran (THF)

Elution rate: 2 mL/min.

Column temperature: 35° C.

Acid value was measured in accordance with Japanese Industrial Standard “K0070:1992. Test methods for acid value, saponification value, ester value, iodine value, hydroxyl value and unsaponifiable matter of chemical products” except that tetrahydrofuran was used instead of diethyl ether as a solvent.

The viscosity of an aqueous pigment dispersion was measured by maintaining the temperature of the aqueous pigment dispersion at 25° C. consistently and subjecting this test sample to Viscometer TVE-22L (produced by TOKI SANGYO CO., LTD.).

### Example 1

Into a 50 L jacketed tank included in a planetary mixer (PLM-50 produced by INOUE MFG., INC.), 3.0 parts by mass of the pigment dispersing resin A and 10.0 parts by mass of C.I. Pigment Violet 23 were sequentially charged. After the temperature of the jacketed tank had been increased to 60° C., 5.0 parts by mass of triethylene glycol and 1.3 parts by mass of a 34 mass % aqueous potassium hydroxide solution were sequentially fed to the jacketed tank. Hereby, a composition (a1-1) was prepared. The composition (a1-1) had a nonvolatile content of 69.6% by mass.

### (Step [1])

While the temperature of the jacketed tank was maintained at 60° C., the composition (a1-1) was stirred and kneaded at a rotation speed of 30 rpm and a revolution speed of 10 rpm for 10 minutes and subsequently further kneaded at a rotation speed of 51 rpm and a revolution speed of 17 rpm for 60 minutes to form a solid kneaded material (a2-1).

### (Step [2])

Ion-exchange water heated at 60° C. was added to the kneaded material (a2-1) in small amounts and stirring was subsequently performed to adjust the pigment concentration to be 15.2% by mass. Then, triethylene glycol diluted with ion-exchange water heated at 60° C. was fed to and mixed with the kneaded material (a2-1). Hereby, a composition (a3-1) having a pigment concentration of 14.7% by mass, a triethylene glycol concentration of 14.7% by mass, and a nonvolatile content of 19.5% by mass was prepared. The viscosity of the composition (a3-1) at 25° C. was 4.0 mPa-s.

### (Step [3])

After the composition (a3-1) had been heated to 60° C. with a heat-exchange apparatus (vacuum steam heating system produced by TLV CO., LTD.), it was continuously subjected to a centrifugation treatment at a centrifugal acceleration of 20000 G while being fed to a cylindrical centrifugal separation apparatus (ultracentrifuge ASM260FH, volumetric capacity of rotor: 7.7 L, produced by TOMOE Engineering Co., Ltd.) at a feed rate of 1.0 L/minute. Hereby, an aqueous pigment dispersion (a4-1) was prepared. The ratio of the amount (volume) of the composition (a3-1) fed to the rotor to the volumetric capacity of the rotor, that is, [Amount (volume) of composition (a3-1) fed/Volumetric capacity of rotor]×100, was 2700%.

### Example 2

An aqueous pigment dispersion (a4-2) was prepared as in Example 1, except that the temperature at which the composition (a3-1) was heated with the heat-exchange apparatus (vacuum steam heating system produced by TLV CO., LTD.) was changed from 60° C. to 40° C.

### Comparative Example 1

An aqueous pigment dispersion (a4-1′) was prepared as in Example 1, except that the temperature at which the composition (a3-1) was heated with the heat-exchange apparatus (vacuum steam heating system produced by TLV CO., LTD.) was changed from 60° C. to 20° C.

### Comparative Example 2

An aqueous pigment dispersion (a4-2′) was prepared as in Example 1, except that the temperature at which the composition (a3-1) was heated with the heat-exchange apparatus (vacuum steam heating system produced by TLV CO., LTD.) was changed from 60° C. to 20° C.; a centrifugal separation apparatus including a rotor having a shape of circular truncated cone (H-600S, volumetric capacity of rotor: 2.0 L, produced by KOKUSAN Co., Ltd.) was used instead of the cylindrical centrifugal separation apparatus (ultracentrifuge ASM260FH, volumetric capacity of rotor: 7.7 L, produced by TOMOE Engineering Co., Ltd.); and the composition (a3-1) was continuously subjected to the centrifugation treatment while being fed to the above centrifugal separation apparatus at a feed rate of 0.25 L/minute.

### Example 3

Into a 50 L jacketed tank included in a planetary mixer (PLM-50 produced by INOUE MFG., INC.), 2.5 parts by mass of the pigment dispersing resin B and 10.0 parts by mass of C.I. Pigment Orange 43 were sequentially charged. After the temperature of the jacketed tank had been increased to 60° C., 3.4 parts by mass of triethylene glycol and 0.9 parts by mass of a 34 mass % aqueous potassium hydroxide solution were sequentially fed to the jacketed tank. Hereby, a composition (a1-3) was prepared. The composition (a1-3) had a nonvolatile content of 76.3% by mass.

### (Step [1])

While the temperature of the jacketed tank was maintained at 60° C., the composition (a1-3) was stirred and kneaded at a rotation speed of 30 rpm and a revolution speed of 10 rpm for 10 minutes and subsequently further kneaded at a rotation speed of 51 rpm and a revolution speed of 17 rpm for 60 minutes to form a solid kneaded material (a2-3).

### (Step [2])

Ion-exchange water heated at 60° C. was added to the kneaded material (a2-3) and stirring was subsequently performed to adjust the pigment concentration to be 16.0% by mass. Then, triethylene glycol diluted with ion-exchange water heated at 60° C. was fed to and mixed with the kneaded material (a2-3). Hereby, a composition (a3-3) having a pigment concentration of 15.6% by mass, a triethylene glycol concentration of 15.6% by mass, and a nonvolatile content of 19.9% by mass was prepared. The viscosity of the composition (a3-3) at 25° C. was 4.0 mPa-s.

### (Step [3])

After the composition (a3-3) had been heated to 60° C. with a heat-exchange apparatus (vacuum steam heating system produced by TLV CO., LTD.), it was continuously subjected to a centrifugation treatment at a centrifugal acceleration of 20000 G while being fed to a cylindrical centrifugal separation apparatus (ultracentrifuge ASM260FH, volumetric capacity of rotor: 7.7 L, produced by TOMOE Engineering Co., Ltd.) at a feed rate of 1.6 L/minute. Hereby, an aqueous pigment dispersion (a4-3) was prepared. The ratio of the amount (volume) of the composition (a3-3) fed to the rotor to the volumetric capacity of the rotor, that is, [Amount (volume) of composition (a3-3) fed/Volumetric capacity of rotor]×100, was 2500%.

### Comparative Example 3

Into a 50 L jacketed tank included in a planetary mixer (PLM-50 produced by INOUE MFG., INC.), 2.5 parts by mass of the pigment dispersing resin C and 10.0 parts by mass of C.I. Pigment Orange 43 were sequentially charged. After the temperature of the jacketed tank had been increased to 60° C., 10 parts by mass of triethylene glycol, 1.3 parts by mass of a 34 mass % aqueous potassium hydroxide solution, and 2.3 parts by mass of ion-exchange water were sequentially fed to the jacketed tank. Hereby, a composition (a1-3′) was prepared. The composition (a1-3′) had a nonvolatile content of 49.6% by mass.

### (Step [1])

While the temperature of the jacketed tank was maintained at 60° C., the composition (a1-3′) was stirred at a rotation speed of 30 rpm and a revolution speed of 10 rpm for 10 minutes and subsequently kneaded at a rotation speed of 51 rpm and a revolution speed of 17 rpm for 60 minutes to form a solid kneaded material (a2-3′).

### (Step [2])

Ion-exchange water heated at 60° C. was added to the kneaded material (a2-3′) and stirring was subsequently performed to adjust the pigment concentration to be 16.5% by mass. Then, triethylene glycol diluted with ion-exchange water heated at 60° C. was fed to and mixed with the kneaded material (a2-3′). Hereby, a composition (a3-3′) having a pigment concentration of 16.2% by mass, a triethylene glycol concentration of 16.2% by mass, and a nonvolatile content of 21.0% by mass was prepared. The viscosity of the composition (a3-3′) at 25° C. was 13.5 mPa-s.

### (Step [3])

After the composition (a3-3′) had been heated to 60° C. with a heat-exchange apparatus (vacuum steam heating system produced by TLV CO., LTD.), it was continuously subjected to a centrifugation treatment at a centrifugal acceleration of 20000 G while being fed to a cylindrical centrifugal separation apparatus (ultracentrifuge ASM260FH, volumetric capacity of rotor: 7.7 L, produced by TOMOE Engineering Co., Ltd.) at a feed rate of 1.6 L/minute. Hereby, an aqueous pigment dispersion (a4-3′) was prepared. The ratio of the amount (volume) of the composition (a3-3′) fed to the rotor to the volumetric capacity of the rotor, that is, [Amount (volume) of composition (a3-3′) fed/Volumetric capacity of rotor]×100, was 2500%.

### Example 4

Into a 50 L jacketed tank included in a planetary mixer (PLM-50 produced by INOUE MFG., INC.), 3.0 parts by mass of the pigment dispersing resin C and 10.0 parts by mass of C.I. Pigment Orange 34 were sequentially charged. After the temperature of the jacketed tank had been increased to 60° C., 3.0 parts by mass of triethylene glycol and 1.6 parts by mass of a 34 mass % aqueous potassium hydroxide solution were sequentially fed to the jacketed tank. Hereby, a composition (a1-4) was prepared. The composition (a1-4) had a nonvolatile content of 65.8% by mass.

### (Step [1])

While the temperature of the jacketed tank was maintained at 60° C., the composition (a1-4) was stirred at a rotation speed of 30 rpm and a revolution speed of 10 rpm for 10 minutes and subsequently kneaded at a rotation speed of 51 rpm and a revolution speed of 17 rpm for 60 minutes to form a solid kneaded material (a2-4).

### (Step [2])

Ion-exchange water heated at 60° C. was added to the kneaded material (a2-4) and stirring was subsequently performed to adjust the pigment concentration to be 16.0% by mass. Then, triethylene glycol diluted with ion-exchange water heated at 60° C. was fed to and mixed with the kneaded material (a2-4). Hereby, a composition (a3-4) having a pigment concentration of 15.6% by mass, a triethylene glycol concentration of 15.6% by mass, and a nonvolatile content of 19.9% by mass was prepared. The viscosity of the composition (a3-4) at 25° C. was 4.0 mPa-s.

### (Step [3])

After the composition (a3-4) had been heated to 60° C. with a heat-exchange apparatus (vacuum steam heating system produced by TLV CO., LTD.), it was continuously subjected to a centrifugation treatment at a centrifugal acceleration of 20000 G while being fed to a cylindrical centrifugal separation apparatus (ultracentrifuge ASM260FH, volumetric capacity of rotor: 7.7 L, produced by TOMOE Engineering Co., Ltd.) at a feed rate of 1.6 L/minute. Hereby, an aqueous pigment dispersion (a4-4) was prepared. The ratio of the amount (volume) of the composition (a3-4) fed to the rotor to the volumetric capacity of the rotor, that is, [Amount (volume) of composition (a3-4) fed/Volumetric capacity of rotor]×100, was 2500%.

### Example 5

An aqueous pigment dispersion (a4-5) was prepared as in Example 4, except that the centrifugal acceleration in the step [3] of the composition (a3-4) was changed from 20000 G to 9000 G.

### Example 6

Into a 50 L jacketed tank included in a planetary mixer (PLM-50 produced by INOUE MFG., INC.), 2.0 parts by mass of the pigment dispersing resin C and 10.0 parts by mass of C.I. Pigment Green 36 were sequentially charged. After the temperature of the jacketed tank had been increased to 60° C., 3.1 parts by mass of triethylene glycol and 1.1 parts by mass of a 34 mass % aqueous potassium hydroxide solution were sequentially fed to the jacketed tank. Hereby, a composition (a1-6) was prepared.

### (Step [1])

While the temperature of the jacketed tank was maintained at 60° C., the composition (a1-6) was stirred at a rotation speed of 30 rpm and a revolution speed of 10 rpm for 10 minutes and subsequently kneaded at a rotation speed of 51 rpm and a revolution speed of 17 rpm for 60 minutes to form a solid kneaded material (a2-6).

### (Step [2])

Ion-exchange water heated at 60° C. was added to the kneaded material (a2-6) and stirring was subsequently performed to adjust the pigment concentration to be 18.1% by mass. Then, triethylene glycol diluted with ion-exchange water heated at 60° C. was fed to and mixed with the kneaded material (a2-6). Hereby, a composition (a3-6) having a pigment concentration of 17.7% by mass, a triethylene glycol concentration of 17.7% by mass, and a nonvolatile content of 21.9% by mass was prepared. The viscosity of the composition (a3-6) at 25° C. was 3.6 mPa-s.

### (Step [3])

After the composition (a3-6) had been heated to 60° C. with a heat-exchange apparatus (vacuum steam heating system produced by TLV CO., LTD.), it was continuously subjected to a centrifugation treatment at a centrifugal acceleration of 20000 G while being fed to a cylindrical centrifugal separation apparatus (ultracentrifuge ASM260FH, volumetric capacity of rotor: 7.7 L, produced by TOMOE Engineering Co., Ltd.) at a feed rate of 0.8 L/minute. Hereby, an aqueous pigment dispersion (a4-6) was prepared. The ratio of the amount (volume) of the composition (a3-6) fed to the rotor to the volumetric capacity of the rotor, that is, [Amount (volume) of composition (a3-6) fed/Volumetric capacity of rotor]×100, was 2100%.

### Example 7

An aqueous pigment dispersion (a4-7) was prepared as in Example 6, except that, in the step [3] of the composition (a3-6), the ratio of the amount (volume) of the composition (a3-4) fed to the rotor to the volumetric capacity of the rotor, that is, [Amount (volume) of composition (a3-6) fed/Volumetric capacity of rotor]×100, was changed from 2100% to 5700%.

### (Method for Producing Ink-Jet Printing Water-Based Ink)

Each of the aqueous pigment dispersions prepared in Examples and Comparative Examples above was mixed with ion-exchange water to form a diluted solution of the aqueous pigment dispersion having a pigment concentration of 6% by mass.

Subsequently, a liquid mixture including 8.0 parts by mass of 2-pyrrolidinone, 8.0 parts by mass of triethylene glycol mono-n-butyl ether, 3.0 parts by mass of glycerin, 0.5 parts by mass of Surfynol 440 (produced by Air Products and Chemicals, Inc.), and 30.5 parts by mass of ion-exchange water was mixed with 50 parts by mass of the diluted solution of the aqueous pigment dispersion. The resulting mixture was stirred. Hereby, an ink-jet printing water-based ink having a pigment concentration of 3% by mass was prepared.

### [Method for Measuring Volume Average Particle Size]

Each of the aqueous pigment dispersions prepared in Examples and Comparative Examples was diluted with ion-exchange water at a specific one of the following dilution factors to prepare a test sample. The volume average particle size of the test sample at 25° C. was measured with a particle size distribution measuring equipment (Microtrac produced by Nikkiso Co., Ltd., Model Name: Nanotrac-UPA150).

TABLE 1

| Pigment included in | Dilution |
|---|---|
| aqueous pigment disperson | factor (times) |
| C.I. Pigment Violet 23 | 5000 |
| C.I. Pigment Orange 43 | 10000 |
| C.I. Pigment Orange 34 | 5000 |
| C.I. Pigment Green 36 | 5000 |

### [Method for Measuring Number of Coarse Particles]

Each of the aqueous pigment dispersions prepared in Examples and Comparative Examples was diluted with ion-exchange water to prepare a test sample. The number of coarse particles having a diameter of 0.5 μm or more which were included in the test sample was measured with a particle-counting particle size distribution analyzer (Accusizer 780 APS produced by Particle Sizing Systems). The number of the coarse particles measured by the above method was multiplied by the specific one of the dilution factors in order to calculate the number of the coarse particles included in 1 mL of the aqueous pigment dispersion prepared in Example or Comparative Example. The dilution factor of the aqueous pigment dispersion was set such that the number of coarse particles having a particle size of 0.5 μm or more which pass through the detector per second fell within a range of 1000 to 4000 particles/ml.

[Method for Evaluating Whether Coarse Particles are Formed in Aqueous Pigment Dispersion with Time (Preservation Stability)]

The number of the coarse particles included in each of the aqueous pigment dispersions immediately after the production was measured by the above-described method.

Subsequently, the aqueous pigment dispersion was hermetically sealed in a polypropylene container and left to stand for 4 weeks at 60° C.

Then, the number of the coarse particles included in the aqueous pigment dispersion that had been left to stand was measured by the above-described method.

A change (%) in the number of the coarse particles which occurred while the aqueous pigment dispersion was left to stand was calculated on the basis of [(Number of coarse particles included in aqueous pigment dispersion that had been left to stand)/(Number of coarse particles included in aqueous pigment dispersion immediately after production)×100] and evaluated in accordance with the following standards.

Good: The change was less than 10%

Poor: The change was 10% or more and less than 20%

Bad: The change was 20% or more

[Method for Evaluating Whether Coarse Particles are Formed in Ink-Jet Printing Water-Based Ink with Time (Preservation Stability)]

The number of the coarse particles included in each of the ink-jet printing water-based inks immediately after the production was measured by the above-described method.

Subsequently, the ink-jet printing water-based ink was hermetically sealed in a polypropylene container and left to stand for 4 weeks at 60° C.

Then, the number of the coarse particles included in the ink-jet printing water-based ink that had been left to stand was measured by the above-described method.

A change (%) in the number of the coarse particles which occurred while the ink-jet printing water-based ink was left to stand was calculated on the basis of [(Number of coarse particles included in ink-jet printing water-based ink that had been left to stand)/(Number of coarse particles included in ink-jet printing water-based ink immediately after production)×100] and evaluated in accordance with the following standards.

Good: The change was less than 10%

Poor: The change was 10% or more and less than 20%

Bad: The change was 20% or more

[Method for Evaluating Whether Pigment, Etc. Included in Ink-Jet Printing Water-Based Ink Settles with Time (Settleability)]

A specific one of the ink-jet printing water-based inks prepared in Examples and Comparative Examples was charged into a glass vial having a volumetric capacity of 10 mL. The glass vial was hermetically sealed and left to stand for 2 weeks at 25° C.

After the ink-jet printing water-based ink had been left to stand, whether sediments, such as the pigment, were adhered on the wall surface of the glass vial when the glass vial was turned upside down was visually inspected. Then, an evaluation was made in accordance with the following standards.

Good: The adhesion of sediments, such as a pigment, on the wall surface of the glass vial was not confirmed.

Poor: The adhesion of sediments, such as a pigment, on the wall surface of the glass vial was confirmed.

Bad: The adhesion of sediments, such as a pigment, on the wall surface of the glass vial was noticeable.

### [Initial Discharge Stability of Ink-Jet Printing Water-Based Ink]

The discharge stability of each of the ink-jet printing water-based inks immediately after production was evaluated with a commercial ink-jet printer ENVY4500 (produced by Hewlett-Packard Development Company, L.P.). A specific one of the ink-jet printing water-based inks was charged into a black cartridge, with which a nozzle check pattern was formed (first nozzle check pattern). Subsequently, a solid image was formed at a print density of 100% in a 340-cm² region of an A4-size paper sheet in a monochrome mode. Then, a nozzle check test pattern was again formed (second nozzle check test pattern). The first and second nozzle check test patterns were compared with each other in order to evaluate the clogging of an ink discharge nozzle.

Excellent: Either the first or second nozzle check test pattern did not have any missing parts.

Good: The number of missing parts confirmed in the first nozzle check test pattern and the number of missing parts confirmed in the second nozzle check test pattern were equal to each other.

Poor: The number of missing parts confirmed in the second nozzle check test pattern was larger than the number of missing parts confirmed in the first nozzle check test pattern by 1 to 5.

Bad: The number of missing parts confirmed in the second nozzle check test pattern was larger than the number of missing parts confirmed in the first nozzle check test pattern by 6 or more.

### [Time-Dependent Discharge Stability of Ink-Jet Printing Water-Based Ink]

A specific one of the ink-jet printing water-based inks immediately after production was charged into a black cartridge and left to stand for 4 weeks at normal temperature.

Then, an evaluation was made with a commercial ink-jet printer ENVY4500 (produced by Hewlett-Packard Development Company, L.P.). The ink-jet printing water-based ink was charged into a black cartridge, with which a nozzle check pattern was formed (first nozzle check pattern). Subsequently, a solid image was formed at a print density of 100% in a 340-cm² region of an A4-size paper sheet in a monochrome mode. Then, a nozzle check test pattern was again formed (second nozzle check test pattern). The first and second nozzle check test patterns were compared with each other in order to evaluate the clogging of an ink discharge nozzle.

Excellent: Either the first or second nozzle check test pattern did not have any missing parts.

Good: The number of missing parts confirmed in the first nozzle check test pattern and the number of missing parts confirmed in the second nozzle check test pattern were equal to each other.

Poor: The number of missing parts confirmed in the second nozzle check test pattern was larger than the number of missing parts confirmed in the first nozzle check test pattern by 1 to 5.

Bad: The number of missing parts confirmed in the second nozzle check test pattern was larger than the number of missing parts confirmed in the first nozzle check test pattern by 6 or more.

TABLE 2

| | | | | Step [3] Conditions | | | | |
|---|---|---|---|---|---|---|---|---|
| | | | | | | | | [Amount |
| | Step | | | | | | | of |
| | [1] | Step [2] | | | | | | com- |
| | Non- | Non- | Vis- | | | | | position |
| | volatile | volatile | cosity | | | Tem- | | (a3)/ |
| | content | content | of | | | perature | | Volu- |
| | in | in | com- | | Volu- | of | Centri- | metric |
| | com- | com- | position | | metric | com- | fugal | capacity |
| | position | position | (a3) at | Shape | capacity | position | accel- | of |
| | (a1) | (a3) | 25° C. | of | of rotor | (a3) | eration | rotor] |
| | (mass %) | (mass %) | (mPa · s) | rotor | (L) | (° C.) | (G) | (%) |
| Example | 69.6 | 19.5 | 4.0 | Cylin- | 7.7 | 60 | 20000 | 2700 |
| 1 | | | | drical | | | | |
| Example | 69.6 | 19.5 | 4.0 | Cylin- | 7.7 | 40 | 20000 | 2700 |
| 2 | | | | drical | | | | |
| Example | 76.3 | 19.9 | 4.0 | Cylin- | 7.7 | 60 | 20000 | 2500 |
| 3 | | | | drical | | | | |
| Example | 65.8 | 21.2 | 5.5 | Cylin- | 7.7 | 60 | 20000 | 2500 |
| 4 | | | | drical | | | | |
| Example | 65.8 | 21.2 | 5.5 | Cylin- | 7.7 | 60 | 9000 | 2500 |
| 5 | | | | drical | | | | |

TABLE 3

| | | | | Step [3] Conditions | | | | |
|---|---|---|---|---|---|---|---|---|
| | | | | | | | | [Amount |
| | Step | Step [2] | | | | | | of |
| | [1] | Non- | Vis- | | | | | com- |
| | Non- | volatile | cosity | | | Tem- | | position |
| | volatile | content | of | | | perature | | (a3)/ |
| | content | in | com- | | | of | | Volu- |
| | in | com- | position | | Volu- | com- | Centri- | metric |
| | com- | position | (a3) at | | metric | position | fugal | capacity |
| | position | (a3) | 25° C. | | capacity | (a3) | accel- | of |
| | (a1) | (mass %) | (mPa · s) | Shape of | of rotor | (° C.) | eration | rotor] |
| | (mass %) | Non- | Vis- | rotor | (L) | Tem- | (G) | (%) |
| Example 6 | 76.4 | 21.2 | 3.6 | Cylindrical | 7.7 | 60 | 20000 | 2100 |
| Example 7 | 76.4 | 21.2 | 3.6 | Cylindrical | 7.7 | 60 | 20000 | 5700 |
| Comparative | 69.6 | 19.5 | 4.0 | Cylindrical | 7.7 | 20 | 20000 | 2700 |
| Example 1 | | | | | | | | |
| Comparative | 69.6 | 19.5 | 4.0 | Circular | 2.0 | 20 | 20000 | 2700 |
| Example 2 | | | | truncated | | | | |
| | | | | cone-like | | | | |
| Comparatve | 49.6 | 21.3 | 13.5 | Cylindrical | 7.7 | 60 | 20000 | 2500 |
| Example 3 | | | | | | | | |

TABLE 4

| | Evaluations | | | | | | |
|---|---|---|---|---|---|---|---|
| | Aqueous | | | | | | |
| | pigment dispersion | | | Ink-jet printing ink | | | |
| | | Number | | | | | Time- |
| | | of | | | | | depen- |
| | Volume | coarse | | | | | dent |
| | average | particles | | | | Initial | dis- |
| | particle | (×10⁶ | Pre- | Pre- | | dis- | charge |
| | size | particles/ | servation | servation | Settle- | charge | sta- |
| | (nm) | mL) | stability | stability | ability | stability | bility |
| Example 1 | 99 | 1000 | Good | Good | Good | Excellent | Good |
| Example 2 | 102 | 1300 | Good | Good | Good | Excellent | Good |
| Example 3 | 130 | 100 | Good | Good | Good | Excellent | Good |
| Example 4 | 85 | 400 | Good | Good | Good | Excellent | Good |
| Example 5 | 85 | 700 | Good | Good | Good | Excellent | Good |
| Example 6 | 92 | 300 | Good | Good | Good | Excellent | Good |
| Example 7 | 92 | 1000 | Good | Good | Good | Good | Good |
| Comparative | 102 | 2500 | Good | Good | Poor | Poor | Bad |
| Example 1 | | | | | | | |
| Comparative | 104 | 3100 | Good | Good | Poor | Poor | Bad |
| Example 2 | | | | | | | |
| Comparative | 165 | 4500 | Bad | Bad | Bad | Bad | Bad |
| Example 3 | | | | | | | |

1. A method for producing an aqueous pigment dispersion, the method comprising a step [1] of kneading a composition (a1) including a pigment including one or more materials selected from the group consisting of a violet pigment, a green pigment, and an orange pigment and a resin, the composition (a1) having a nonvolatile content of 50% by mass or more, to produce a kneaded material (a2); a step [2] of mixing at least the kneaded material (a2) and an aqueous medium with each other to produce a composition (a3); and a step [3] of subjecting the composition (a3) to a centrifugation treatment at 30° C. to 70° C.

2. The method for producing an aqueous pigment dispersion according to claim 1, wherein the step [3] is a step in which a cylindrical centrifugal separation apparatus is used.

3. The method for producing an aqueous pigment dispersion according to claim 1, wherein the step [3] is a step in which a composition having a viscosity of 13 mPa-s or less at 25° C., the composition being the composition (a3), is subjected to the centrifugation treatment with a cylindrical centrifugal separation apparatus.

4. The method for producing an aqueous pigment dispersion according to claim 2, wherein the step [3] is a step conducted while the composition (a3) is fed to a rotor included in the cylindrical centrifugal separation apparatus and a temperature of the composition (a3) is maintained at 30° C. to 70° C. wherein a ratio of an amount (volume) of the composition (a3) fed to the rotor to a volumetric capacity of the rotor, that is, [Amount (volume) of composition (a3) fed/Volumetric capacity of rotor]×100, is 1000% to 8000%, and wherein a centrifugal acceleration of the cylindrical centrifugal separation apparatus is 8000 to 20000 G.

5. The method for producing an aqueous pigment dispersion according to claim 1, wherein a kneading apparatus used in the step [1] is a closed kneading apparatus.

6. The method for producing an aqueous pigment dispersion according to claim 5, wherein the kneading apparatus is a planetary mixer.

7. The method for producing an aqueous pigment dispersion according to claim 1, wherein the step [2] is a step in which the aqueous medium is fed to the kneaded material (a2) in order to adjust a nonvolatile content to be 10% to 30% by mass.

8. The method for producing an aqueous pigment dispersion according to claim 1, wherein the composition (a1) includes at least a pigment, a resin, a basic compound, and a water-soluble organic solvent.
